(19) United States
(12) Patent Application Publication
(10) Pub. No.: US 2010/0158624 A1
(43) Pub. Date: Jun. 24, 2010

(54) Mobile drilling device for creating multiple bore holes in a building component

(75) Inventors: Gerhard Greisl, Kaufening (DE); Horst Schloemer, Utting (DE)

Correspondence Address: Davidson, Davidson & Kappel, LLC, 485 7th Avenue, 14th Floor, New York, NY, 10018, US

(73) Assignee: Hilti Aktiengesellschaft, Schaan (LI)

(21) Appl. No.: 12/592,794

(22) Filed: Dec. 3, 2009

(30) Foreign Application Priority Data
Dec. 4, 2008 (DE) 10 2008 044 352.2

(51) Int. Cl. B23B 39/16; B23B 49/02; B23B 35/00

(52) U.S. Cl. 408/1 R; 408/43; 408/241 B; 408/46

(57) ABSTRACT

A mobile drilling device for creating multiple bore holes in a building component having a plurality of stand-guided drill units spaced a distance apart from one another according to the drill pattern to be created is described. These drill units are movable relative to the building component via a feed mechanism and have a base frame on which the stand-guided drill units are secured. The base frame includes a base plate, which is spaced a distance apart from the drill units and has at least one guide opening for guiding the tools of these drill units as well as an adjusting device, which comes in contact with the building component and with which the base frame is alignable relative to the building component. In addition, a method for creating multiple bore holes in a building component is described.

This claims the benefit of German Patent Application No. 10 2008 044 352.2, filed on Dec. 4, 2008 and hereby incorporated by reference herein.

The present invention relates to a mobile drilling device for creating multiple bore holes in a building component and a method for creating multiple bore holes using a drilling device.

### BACKGROUND

Elements such as façade elements of a curtain wall or restraint systems, e.g., guide rails, balustrades or the like have fastening points for attaching them to a building component, these fastening points being situated at uniform intervals from one another. Therefore, multiple bore holes are created in the building component, their drill pattern and spacing from one another corresponding to the design and configuration of the attachment points of the element to be secured. To ensure simple installation of the elements to be secured on the building component and to avoid unnecessary stresses as well as the resulting damage to the element to be secured, an accurate implementation of the bore holes is necessary.

To this end, U.S. Pat. No. 4,915,549 describes a mobile drilling device for creating multiple bore holes in the building component, the drilling device having four stand-guided, individually controlled drill units spaced apart from one another, each drill unit being positionable via a positioning device relative to another drill unit and movable relative to the building component via a feed device. The stand-guided drill units are secured on a base frame, which is in turn situated on a movable working scissor-lift platform.

The drilling device according to U.S. Pat. No. 4,915,549 is moved to the desired location with respect to the building component in which the bore holes are to be drilled and then the drill units are positioned in the proper position for simultaneously creating four bore holes in the building component. After activation of all drilling devices, they are moved relative to the building component via the feed device using a pressing force, so that four bore holes having the same drill pattern are created at the same time. After achieving the desired drilling depth, the drill units are retracted to their starting positions. Additional multiple bore holes are next drilled at a distance from the bore holes created previously in the building component by using this drilling device.

### SUMMARY OF THE INVENTION

One disadvantage of the known approach is that only essentially horizontally oriented bore holes may be drilled in vertically oriented surfaces of building components by using this drilling device. Furthermore, vertical bore holes may be drilled using the known drilling device on the corresponding surface of the building component only to a limited extent. Furthermore, the tools of the drill units in the drilling method according to U.S. Pat. No. 4,915,549 are subject to considerable wear.

It is an object of the present invention to provide a mobile drilling device for drilling multiple bore holes in the building component which creates vertical multiple bore holes in the building components oriented essentially horizontally, so that the drill patterns created are embodied accurately and the drilling device is easy to handle. Furthermore, the object of the present invention is to create a method for drilling multiple bore holes in a building component by using a drilling device in which the tools of the drill units are exposed to less wear.

The present invention provides a mobile drilling device for creating multiple bore holes in a building component, having a plurality of stand-guided drill units spaced a distance apart from one another according to the drill pattern to be created and movable relative to the building component via a feeding mechanism, and having a base frame on which the stand-guided drill units are secured. According to the present invention, the base frame includes a base plate at a distance from the drill units, having at least one guide opening for guiding the tools of these drill units, as well as an adjusting device coming in contact with the building component, the base frame being alignable relative to the building component.

The tools of the drill units are guided close to the building component, together with the base plate facing the building component and the at least one guide opening, so that the bore holes are created very precisely in the building component. The base frame may be aligned accurately relative to the building component via the adjusting device. With the combination of the additional guide and the adjustability of the base frame, creation of bore holes aligned perpendicular to the corresponding surface is ensured, the number of bore holes being drilled at the same time corresponding to the number of drill units present.

The base frame is advantageously a frame construction, in which a control for the drill units and a medium storage for operation of the feed device of the drill units, e.g., a pneumatic system, are situated in this frame construction. In addition, a roof to protect the building components of the drilling device from weather conditions is also advantageously provided. Tarps are also advantageously provided on the side walls of the frame construction as a splashguard for the building components of the drilling device. The drilling device may thus also be exposed to rainfall or snow.

A number of guide openings corresponding at least to the number of drill units is preferably provided for guiding the tools of these drill units in the base plate, so that a guide facing the building component is provided for each tool of a drill unit. In one variant, more guide openings than the number of drill units are provided, so they are advantageously arranged in pairs and in two parallel lines. This makes it possible to create different drill patterns using one drilling device.

Preferably at least four guide openings arranged in a rectangle are provided in the base plate, so that drill patterns for securing posts of a restraint system are advantageously creatable. Such posts are usually secured on the building component using four anchors such as a bridge cordon.

Preferably at least two guide openings are designed as elongated holes, their longitudinal extent being oriented in the same direction, so that different drill patterns may be created using one drilling device. To vary the drill pattern, for example, two of the drill units, whose tools are guided in the guide openings designed as elongated holes, are displaced according to the longitudinal alignment of the elongated holes relative to the other drill units, which are situated in a stationary position above the other guide openings and whose tools are guided in these guide openings.

A guide bushing for centering the tools of at least one drill unit is preferably provided in each of the guide openings, so that accurate guidance of the corresponding tool is ensured. The guide bushings are preferably made of a material which produces low friction between the guide bushing and the corresponding tool. This greatly reduces the wear on the guide bushing.

The guide bushings are preferably secured replaceably in the guide openings and may thus be replaceable after reaching a certain wear. If one or more guide bushings are worn and thus no longer ensure satisfactory tool guidance, the worn guide bushings may be replaced by new ones, so that satisfactory tool guidance is again achieved.

If guide bushings are provided in the guide openings designed as elongated holes, then they are advantageously displaceably situated therein. It is thus easy to adapt the guide bushings to the previously adjustable arrangement of the drill units in the elongated hole.

The guide bushings preferably have an insertion bevel facing the drill units, receiving the free ends of the tools, which are sometimes tumbling, as the drill units are lowered and/or advanced in the direction of the building component, and steering the free ends into their advantageously cylindrical guide area.

The insertion bevel of the guide bushing preferably forms an angle of 40° to 80°, advantageously 50° to 70°, with the drilling axis of the tool, ensuring an advantageous feed of the free end of the tool into the guide area of the guide bushing.

The adjusting device preferably includes multiple adjusting elements, which engage displaceably in mating elements for height adjustment of the base frame relative to the building components. The adjusting elements stand on the building component during the drilling operation, during which at least three adjusting elements engage in mating elements relative to the building component or the base plate. The adjusting elements are advantageously provided in the corners of the base frame. The adjusting elements advantageously have a supporting plate for support on the building component and a spindle protruding away from the supporting plate and engaging in a suitably designed mating element. The mating element may be, for example, a separate part or an element integrated directly into the base frame. For example, the spindle of the adjusting element is provided with a thread, e.g., an outside thread, which engages in a mating thread, e.g., an inside thread on the mating element. Such a mating element is designed, for example, as a nut welded to the base frame. In addition, a lifting mechanism such as a crank arrangement may also be provided, by which the adjusting device is adjustable manually or by motor for adjustment of the base frame, for example.

A drill pattern spacing device is preferably provided for creating a plurality of drill patterns to be created so they are equidistant from one another, and it allows a simple and accurate method of creating a plurality of drill patterns at a distance from one another such as those desired and/or required, e.g., for securing restraint systems in road construction.

The drill pattern spacing device preferably includes an anchor element insertable into a bore hole and a flexible spacer means, whose length is advantageously adjustable, connected to the anchor element and to the base frame. After creating a drill pattern, the anchor element, e.g., a bolt or a mandrel, is inserted into one of the previously created bore holes and the drilling device is displaced along the building component until the flexible spacer means, e.g., a chain, is under tension. The flexible spacer means is adjusted in its length so that in the tensed state of the spacer means, the desired distance between the drill patterns is obtained. Using this drill pattern spacing device, accurate spacing of drill patterns relative to one another is ensured without the assistance of any other measurement means, even with curved surfaces of the building component.

A repositioning device which is out of function during the drilling operation is preferably provided on the base frame for repositioning the drilling device. Before or after creation of the bore holes in the desired positions on the building component, corresponding parts of the repositioning device are brought into contact with the surface of the building component, so the drilling device is repositionable with little expenditure of force.

The repositioning device preferably includes at least two rollers, which may be offset relative to the building component, so that the drilling device is easily displaceable. For example, two rollers are provided on one side of the base frame and, at a distance therefrom, a handle is provided on the base frame by which the drilling device is tiltable and guidable about the roller axis.

In an advantageous variant, two rollers are provided on opposing sides of the base frame, e.g., on the base plate, and are movable in the direction of the building component via an advantageously controlled lifting device for repositioning the drilling device, and they raise the base frame so that the adjusting device is no longer in contact with the building component. After the drilling device has been positioned in the new location, the rollers are again moved in the direction of the base frame, so that the base frame is lowered because of its own weight until the adjusting device is again in contact with the building component. For example, the rollers are offset relative to the substrate via a pneumatic or hydraulic mechanism.

An adjustable side guidance device is preferably provided on the base frame for guiding the drilling device at a certain distance from an edge of the building component, this distance easily being kept constant with repositioning of the drilling device.

The method according to the present invention relates to the creation of multiple bore holes in a building component by using a drilling device having a plurality of stand-guided, individually controlled drill units, which are spaced a distance apart from one another in a base frame of the drilling device, according to the drill pattern to be created and are movable relative to the building component via a feeding mechanism.

The drilling device is first positioned in the desired position on the building component and is aligned using the adjusting device situated on the base frame and brought into contact with the building component so it is perpendicular relative to the building component. All the drill units are then activated at the same time. The drills are advanced along the stands at the same pressing force in the direction of the building component, so the free ends of the tool are held in the guide openings in the base plate—if the tools are not already guided into the guide openings—and are guided there for the remaining drilling operation. The pressing force for the drill units is advantageously preadjustable.

As soon as one or more drill units has reached the preset drilling depth in the building component, this drill unit is automatically shut down by a control. After all drill units have been shut down and thus each drill unit has reached the preset drilling depth in the building component, all the drill units are again activated by the control. Next all the drill units together with the rotationally driven tools are returned to a starting position of the drill units simultaneously and advantageously in synchronization.

Since the drill units create the bore holes independently of one another, unnecessary operation and thus wear on the tools in the bore hole is prevented, thus greatly increasing tool lifetime.

When the drilling operation is terminated by a stop switch, the drill units are preferably retracted simultaneously, with the rotationally driven tools being retracted into their starting positions and then all the drill units being shut down, which additionally reduces the wear on the tools in this application case in comparison with the known approaches in which the drill units are only shut down.

### BRIEF DESCRIPTION OF THE DRAWINGS

The present invention is explained in greater detail below on the basis of an exemplary embodiment:

FIG. 1 shows a drill device in a side view;

FIG. 2 shows a view of the base plate from above according to line II-II in FIG. 1;

FIG. 3 shows a view of a stand having a drill unit; and

FIG. 4 shows a guide bushing in a sectional view.

### DETAILED DESCRIPTION

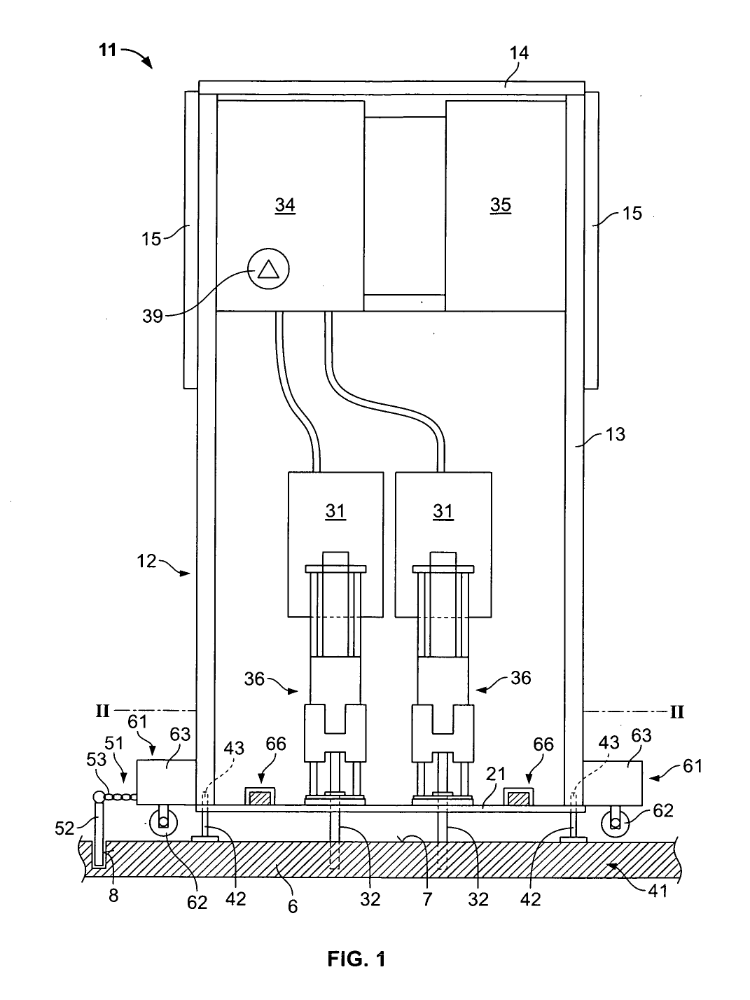

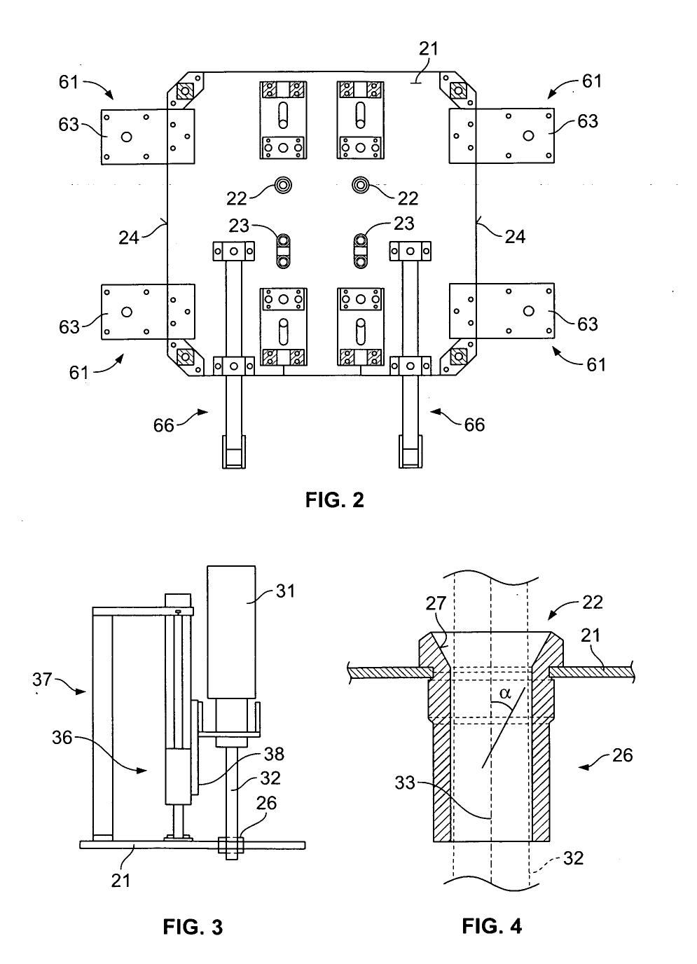

Mobile drilling device 11 shown in FIGS. 1 through 4 for creating multiple bore holes in a building component 6 has four drill units 31, which are spaced a distance apart according to the drill pattern to be created, guided on a stand 37 (FIG. 3) and movable relative to building component 6 via a pneumatic feed device 36 and a base frame 12 on which stands 37 of drill units 31 are secured. Drill units 31 are detachably secured on a slide 38, which is movable along stand 37 by feed device 36 for being fed to building component 6 and for a return of drill units 31 back to a starting position away from building component 6. Core drill crowns as tools 32 are rotationally driven by drill units 31.

Base frame 12 has a frame construction 13, which has a roof 14 as weather protection and has a splash-guard tarp 15 in the upper area on the sides. Drill units 31 are controlled individually, i.e., separately from one another by a control 34 situated in frame construction 13 beneath roof 14. In addition, a pneumatic unit 35 for feed mechanisms 36 of drill units 31 is provided in frame construction 13 beneath roof 14.

In addition, base frame 12 includes a base plate 21, which is spaced a distance away from drill units 31 and has four guide openings 22 and 23 situated in a rectangle for guiding tools 32 of these drill units 31. Both guide openings 23 are designed as elongated holes whose longitudinal extent is oriented in the same direction.

A guide bushing 26 for centering corresponding tool 32 is provided in each guide opening 22 and 23, so that guide bushings 26 are replaceably secured in guide openings 22 and 23. Guide bushings 26 are displaceably situated in guide openings 23 designed as elongated holes. Guide bushings 26 each have an insertion bevel 27 facing drill units 31 and forming an angle (alpha) of 40° to 80°, advantageously 50° to 70°, to drill axis 33 of tool 31.

Guide openings 22 and 23 are designed and situated so that a drill pattern having four bore holes 8 at an axial spacing of 200 mm×200 mm and drill pattern having four bore holes 8 at an axle spacing of 200 mm×150 mm, for example, may be created using drilling device 11.

Base frame 12 also has an adjusting unit 41, which comes in contact with building component 6 and with which base frame 12 is alignable relative to building component 6. Adjusting unit 41 includes four adjusting elements 42, which engage in threaded bushings provided on frame construction 12 as mating elements 43 for height adjustment of base frame 12 relative to building component 6.

In addition, a drill pattern spacing device 51 is provided for creating a plurality of drill patterns to be created at the same spacing, including an anchor element 52 insertable into a previously created bore hole 8 and a flexible length-adjustable chain as spacer means 53 connected to anchor element 52 and base frame 12.

For repositioning of drilling device 11, a repositioning device 61 is provided on base frame 12, which is nonfunctional during the drilling operation. Repositioning device 61 includes two rollers 62 situated on two opposite sides 24 of base plate 21, movable relative to building component 6 by a pneumatic lifting mechanism 63.

For guidance of drilling device 11 at a certain distance from an edge of building component 6, an adjustable side guidance mechanism 66 is provided on base plate 21.

An inventive method for creating multiple bore holes in building component 6 using drilling device 11 is explained below.

Drilling device 11 is first positioned in the desired position on building component 6, to which end rollers 62 of repositioning device 61 are moved in the direction of building component 6 until they are in contact with surface 7 of building component 6 and entire base frame 12 is lifted. In this position of repositioning device 61, adjusting device 41 is no longer in contact with building component 6. Rollers 62 are next retracted by lifting mechanism 63, entire base frame 12 being moved in the direction of building component 6 by the force of gravity, and adjusting elements 42 of adjusting mechanism 41 again coming in contact with building component 6. In this position of rollers 62, repositioning device 61 is nonfunctional.

By moving adjusting elements 42 relative to base frame 12, drilling device 11 is aligned perpendicular relative to building component 6. All drill units 31 are activated simultaneously via an ON switch.

All drill units 31 are displaced in the direction of building component 6 with the same preset pressing force by feed mechanism 36, tools 32 being guided in guide bushings 26 situated in guide openings 22 and 23. As soon as a drill unit 31 has reached the present drilling depth in building component 6, this drill unit 31 is automatically shut down. Other drill units 31 remain in operation until reaching the preset drilling depth.

After all drill units 31 have been shut down and thus each drill unit 31 has reached the preset drilling depth in building component 6, all drill units 31 are again activated by control 34 and are retracted simultaneously and advantageously in synchronization into a starting position of drill units 31 together with rotationally driven tools 32. Drilling device 11 is available for a new drilling operation and may now be repositioned.

A stop switch 39 is provided on control 34, and when operated, the drilling operation is interrupted and drill units 31 are automatically retracted together with rotationally driven tools 32 back into their starting positions simultaneously and advantageously in synchronization and are then shut down.

What is claimed is:

1. A mobile drilling device, for creating multiple bore holes in a building component, comprising:
a plurality of stand-guided drill units spaced a distance apart from one another according to a drill pattern to be created and movable relative to the building component via a feeding mechanism; and
a base frame, the stand-guided drill units being secured on the base frame, the base frame including a base plate spaced a distance apart from the drill units, and having at least one guide opening for guiding the tools of the drill units, and including an adjusting device coming in contact with the building component, the base frame being alignable relative to the building component with the adjusting device.

2. The drilling device as recited in claim 1 wherein at least a number of the at least one guide opening corresponds to the number of drill units for guiding the tools in the base plate.

3. The drilling device as recited in claim 2 wherein the at least one guide opening includes at least four guide openings situated in a rectangle in the base plate.

4. The drilling device as recited in claim 2 wherein the at least one guide opening includes at least two guide openings designed as elongated holes whose longitudinal extent is oriented in a same direction.

5. The drilling device as recited in claim 1 further comprising a guide bushing for centering the tools of at least one drill unit in each of the guide openings.

6. The drilling device as recited in claim 5 wherein the guide bushing is replaceably secured in the guide opening.

7. The drilling device as recited in claim 5 wherein the guide bushing has an insertion bevel facing the drill units.

8. The drilling device as recited in claim 7 wherein the insertion bevel of the guide bushing forms an angle of 40° to 80° with a drilling axis of the tool.

9. The drilling device as recited in claim 8 wherein the angle is of 50° to 70°.

10. The drilling device as recited in claim 1 wherein the adjusting device includes a plurality of adjusting elements engaging in mating elements for adjustment of the height of the base frame relative to the building component.

11. The drilling device as recited in claim 1 further comprising a drill pattern spacing device for creating a plurality of drill patterns to be created at a same distance from one another.

12. The drilling device as recited in claim 11 wherein the drill pattern spacing device includes an anchor element insertable into a previously adjusted bore hole and a flexible spacer connected to the anchor element and the base frame.

13. The drilling device as recited in claim 12 wherein the flexible spacer is adjustable in length.

14. The drilling device as recited in claim 1 further comprising a repositioning device on a base frame for repositioning the drilling device, the drilling device being nonfunctional during the drilling operation.

15. The drilling device as recited in claim 14 wherein the repositioning device includes at least two rollers displaceable relative to the building component.

16. The drilling device as recited in claim 1 further comprising an adjustable side guide on the base frame for guiding the drilling device at a certain distance from an edge of the building component.

17. A method for creating multiple bore holes in a building component having a drilling device having a plurality of stand-guided drill units movable relative to the building component via a feeding mechanism and spaced a distance apart from one another according to the drill pattern to be created, as well as having individually controlled drill units, all being situated in a base frame of the drilling device, the method comprising the steps of:
positioning the drilling device in a desired position on the building component;
perpendicularly aligning the drilling device relative to the building component by an adjusting device situated on the base frame and brought in contact with the building component;
simultaneously activating all of the drill units;
advancing all of the drill units in a direction of the building component using a same pressing force;
automatically shutting down the drill unit which has reached a preset drilling depth in the building component;
reactivating all of the drill units by a control after all of the drill units have been shut down and thus each drill unit has reached the present drilling depth in the building component; and
simultaneously retracting all of the drilling devices together with rotationally driven tools into a starting position of the drill units.

18. The method as recited in claim 17 wherein the pressing force is preset.

19. The method as recited in claim 17 wherein, on termination of the drilling operation via a stop switch, the drill units are retracted simultaneously together with the rotationally driven tools back into their starting position and then all drill units are shut down.
